(19) United States
(12) Patent Application Publication
(10) Pub. No.: US 2016/0378012 A1
(43) Pub. Date: Dec. 29, 2016

(54) CHARGING MEMBER

(71) Applicant: SUMITOMO RIKO COMPANY LIMITED, Komaki-shi (JP)

(72) Inventors: Masanori Satoh, Tajimi-shi (JP); Satoshi Tatsumi, Komaki-shi (JP); Yukio Oyama, Komaki-shi (JP); Masanori Ishida, Komaki-shi (JP); Koji Morihara, Komaki-shi (JP)

(73) Assignee: SUMITOMO RIKO COMPANY LIMITED, Komaki-shi (JP)

(21) Appl. No.: 15/264,005

(22) Filed: Sep. 13, 2016

Related U.S. Application Data
(63) Continuation of application No. PCT/JP2015/071692, filed on Jul. 30, 2015.

(30) Foreign Application Priority Data
Sep. 25, 2014 (JP) 2014-195101

(51) Int. Cl. G03G 15/02

(52) U.S. Cl. CPC G03G 15/0233

(57) ABSTRACT

There is provided a charging member (1) capable of improving adhesion of an elastic layer (3) with a surface layer (4), which is used for an electrophotographic image forming device. The charging member (1) has a shaft body (2) having conductivity, the elastic layer (3) having conductivity which is formed along the outer circumference of the shaft body (2), and the surface layer (4) formed along the outer circumference of the elastic layer (3). The elastic layer (3) contains a rubber and a calcium carbonate having a spindle shape. The surface layer (4) is composed of a cured material of a composition containing a matrix polymer, a polyisocyanate having two or more isocyanate groups in a molecule, and a porous particle. The calcium carbonate in the elastic layer (3) exists more at a side closer to the surface layer (4) than at a side closer to the shaft body (2).

### TECHNICAL FIELD

The present disclosure relates to a charging member.

### BACKGROUND ART

There are conventionally known electrophotographic image forming devices using charged images, such as copiers, printers and facsimiles. These image forming devices carry out image formation through any steps including formation of latent images on a charged photoreceptor by exposure of image data, development, transfer to a transfer medium, fixation, and the like. In a step of latent image formation, a roll-shaped charging member is usually used in order to charge a photoreceptor surface.

As the charging member, there is disclosed, for example, in Patent Document 1, a charging member having a conductive support, a conductive elastic layer formed on the conductive support and containing aggregates of spindle-shaped calcium carbonate, and a surface layer provided on the elastic layer.

### PRIOR ART DOCUMENT

### Patent Document

Patent Document 1: JP-A-2009-9056

### SUMMARY OF THE INVENTION

Conventional technologies, however, have a problem in the following point. That is, the spindle-shaped calcium carbonate contained in the elastic layer serves to make a surface of the elastic layer smooth. The elastic layer containing the spindle-shaped calcium carbonate, however, is low in adhesion with the surface layer. As a result, in the case where the charging member is used for a long period, the surface layer becomes liable to be peeled off from the elastic layer. The generation of the peeling-off of the surface layer causes an impediment to the charging of a photoreceptor by the charging member, and deteriorates the durability of the image forming device.

The present disclosure has been achieved in consideration of the above background, and will provide a charging member capable of improving the adhesion of an elastic layer with a surface layer as compared with conventional charging members.

An aspect of the present disclosure provides a charging member for use in an electrophotographic image forming device,

the charging member including:
a shaft body having conductivity;
an elastic layer having conductivity and formed along an outer circumference
   e of the shaft body; and
a surface layer formed along an outer circumference of the elastic layer; wherein
the elastic layer includes a rubber and a calcium carbonate having a spindle shape,
the surface layer includes a cured material of a composition including a matrix polymer, a polyisocyanate having two or more isocyanate groups in a molecule, and a porous particle; and
the calcium carbonate in the elastic layer exists more at a side closer to the surface layer than at a side closer to the shaft body.

The charging member has an elastic layer including a rubber and a calcium carbonate having a spindle shape, and a surface layer including a cured material of a composition including a matrix polymer, a polyisocyanate having two or more isocyanate groups in a molecule, and a porous particle. Hence, the charging member can be improved in the adhesion of the elastic layer with the surface layer as compared with conventional charging members. Therefore, in the charging member, even in the case of being used for a long period, the surface layer is scarcely peeled off from the elastic layer.

The mechanisms of improving the adhesion of the elastic layer with the surface layer are presumed as follows. When the composition used for the formation of the surface layer is cured on the elastic layer containing the calcium carbonate having a spindle shape, the polyisocyanate having been self-crosslinked enters pores of the porous particle. Further, COOH groups, OH groups and the like present on the surface of the calcium carbonate in the elastic layer react with isocyanate groups of the polyisocyanate. It is conceivable that the elastic layer and the surface layer are crosslinked so that the adhesion of the elastic layer with the surface layer is improved.

### BRIEF DESCRIPTION OF DRAWINGS

FIG. 1 is a view illustratively showing a charging member of Example 1.

FIG. 2 is a view showing the II-II cross-section in FIG. 1.

### MODE FOR CARRYING OUT THE INVENTION

The charging member is used for electrophotographic image forming devices. Specifically, examples of the electrophotographic image forming device include copiers, printers, facsimiles, multi-function machines, POD (Print On Demand) machines and the like which employ electrophotography using a charged image.

In the charging member, the shaft body is not especially limited as long as having conductivity so that a voltage can be applied to the shaft body. Specific examples of the shaft body include solid bodies (core metals) or hollow bodies composed of a metal (including alloys) such as stainless steel, aluminum or iron, solid bodies or hollow bodies composed of a conductive plastic, and metal-plated solid bodies or hollow bodies composed of a conductive or non-conductive plastic. Here, an adhesive may be applied on the outer circumference of the shaft body.

In the charging member, the elastic layer includes a rubber and a calcium carbonate having a spindle shape.

In the charging member, examples of the rubber contained in the elastic layer include isoprene rubber (IR), natural rubber (NR), styrene-butadiene rubber (SBR), butadiene rubber (BR), acrylonitrile-butadiene rubber (NBR), hydrin rubber (ECO, CO), ethylene-propylene-diene rubber (EPDM), urethane rubber (U) and silicone rubber (Q). Among these rubbers, there can suitably be used one or more rubbers selected from the group consisting of isoprene rubber, natural rubber, styrene-butadiene rubber, butadiene rubber, acrylonitrile-butadiene rubber and hydrin rubber. This case has advantages of being easily processed, easily providing conductivity and the like. The case further has advantages of easily achieving cost reduction and the like. Among the above rubbers, isoprene rubber can more suitably be used. Since isoprene rubber has few reactive groups, the adhesion with the surface layer is usually difficult to be secured. By employing the above constitution, however, since the adhesion of the elastic layer with the surface layer is improved, the above-mentioned effect can sufficiently be exhibited. Further isoprene rubber is comparatively inexpensive. Hence, in this case, the cost reduction of the charging member can easily be achieved.

In the charging member, the calcium carbonate contained in the elastic layer has a spindle shape. As the calcium carbonate, specifically, from the viewpoint of comparatively easily providing a calcium carbonate having a spindle shape, there can suitably be used a calcium carbonate having a crystal structure of calcite type.

The average aspect ratio of the calcium carbonate is, from the viewpoints to easily make the elastic layer surface smooth, and the like, preferably 1.0 or higher, more preferably 1.5 or higher, and still more preferably 2.0 or higher. The average aspect ratio of the calcium carbonate is, from the viewpoints of easy availability, and the like, preferably 5.0 or lower, more preferably 4.0 or lower, and still more preferably 3.0 or lower. Here, the average aspect ratio is an average value of ratios of major diameters to minor diameters of calcium carbonate particles. The minor diameter and the major diameter of the calcium carbonate particle can be measured using a scanning electron microscope. Further the major diameter of the calcium carbonate particle may be, from the viewpoint of easy appearance onto the elastic layer surface, preferably 50 nm or longer, more preferably 100 nm or longer, and still more preferably 300 nm or longer. The major diameter of the calcium carbonate particle may be, from the viewpoint of processability and the like, preferably 3,000 nm or shorter, more preferably 2,000 nm or shorter, and still more preferably 1,200 nm or shorter.

In the charging member, the elastic layer can contain 10 to 150 parts by mass of the calcium carbonate relative to 100 parts by mass of the rubber. In this case, the adhesion of the elastic layer with the surface layer is easily improved while the smoothness of the elastic layer surface is secured. The content of the calcium carbonate can be, from the viewpoint of easy securing of the smoothness of the elastic layer surface and the adhesion of the elastic layer with the surface layer, and the like, preferably 15 parts by mass or higher, more preferably 20 parts by mass or higher, and still more preferably 25 parts by mass or higher. The content of the calcium carbonate can be, from the viewpoint of the processability, the adhesion of the elastic layer with the skin layer, and the like, preferably 145 parts by mass or lower, more preferably 140 parts by mass or lower, and still more preferably 135 parts by mass or lower.

In the charging member, the elastic layer can contain a conductive agent. Examples of the conductive agent include electron conductive agents, ionic conductive agents and conductive polymers. Examples of the electron conductive agent include carbon-based conductive materials, conductive metal oxides and metal nanoparticles. Examples of the carbon-based conductive materials include carbon black, carbon nanotubes and graphite. Examples of the conductive metal oxides include barium titanate, c-TiO₂, c-ZnO and c-SnO₂ (c- means being conductive). Examples of the ionic conductive agent include quaternary ammonium salts, borate salts, perchlorate and ionic liquids. Examples of the conductive polymers include polyaniline and polypyrrole.

In the charging member, the elastic layer can contain, other than the conductive agent, one or more of various types of additives, for example, vulcanizing aids, vulcanizing agents, vulcanizing accelerators, fillers, lubricants, reinforcing agents, crosslinking agents, crosslinking auxiliary agents, processing auxiliary agents, plasticizers, antioxidants, ultraviolet absorbents, pigments and surfactants.

In the charging member, it is preferable that the calcium carbonate in the elastic layer exists more at a side closer to the surface layer than at a side closer to the shaft body. In this charging member, the surface layer is hardly peeled off from the elastic layer during the long-term usage of the charging member. This is conceivably because the phenomenon caused by the above-mentioned presumed mechanism occurs more easily around the interface between the elastic layer and the surface layer and the adhesion force between the elastic layer and the surface layer is much more enhanced.

In the charging member, it is preferable that the calcium carbonate in the elastic layer is oriented in the state that the major axis of the calcium carbonate in the elastic layer is directed in the axis direction of the shaft body. This case has effects to improve the adhesion with the surface layer, the restorability of the elastic layer itself, and so on. Further in this case, since the calcium carbonate is regularly disposed, the smoothness of the elastic layer surface is easily secured.

In the charging member, it is preferable that the elastic layer is formed by extrusion. In this case, the major axis of the calcium carbonate is easily oriented in the state of being directed in the extrusion direction that is the same direction as the axis direction of the shaft body. Hence, in this case, it becomes easy to provide the elastic layer containing the calcium carbonate oriented in the state that the major axis of the calcium carbonate is directed in the axis direction of the shaft body.

In the charging member, the thickness of the elastic layer can be made to be, from the viewpoint of the improvement in the restorability from the deformation due to the contact with a photoreceptor, the suppression of material fracture due to energization, and so on, preferably about 0.2 to 20 mm, more preferably about 0.5 to 10 mm, and still more preferably about 1 to 5 mm.

In the charging member, the volume resistivity of the elastic layer can be made to be, from the viewpoint of the improvement in the charging ability, the suppression of material fracture due to energization, and so on, preferably about 1×10² to 1×10¹⁰ Ω·cm, and more preferably about 1×10³ to 1×10⁹ Ω·cm.

In the charging member, the surface layer includes a cured material of a composition containing a matrix polymer, a polyisocyanate having two or more isocyanate groups in a molecule, and a porous particle.

The matrix polymer contained in the composition for forming the surface layer is a component for forming a fundamental skeleton of the surface layer. Examples of the matrix polymer include (meth) acrylic resins, urethanic resins, polyamide resins, fluororesins, epoxy resins, and urea resins. Here, in the present application, the “(meth)acrylic resins” is defined to include both of acrylic resins and methacrylic resins.

Among these matrix polymers, preferably, there can suitably be used (meth)acrylic resins, urethanic resins, polyamide resins and so on. These resins are comparatively hard. Hence, in this case, since the surface layer becomes comparatively hard, a toner and external additives hardly stick in the surface layer surface so as to easily reduce fouling due to adhesion of the toner and the external additives. Further in this case, since the surface layer hardly becomes so excessively hard as to shave a photoreceptor, damage to the photoreceptor is easily suppressed. As the (meth)acrylic resins, specifically, there can suitably be used the (meth)acrylic resins having a silicone group and/or a fluorine-containing group. In the case of having a silicone group, slidability of the surface layer surface can be improved. In the case of having a fluorine-containing group, the toner adhered to the surface layer surface is easily separated and the toner filming and the like are easily suppressed. Here, the “fluorine-containing group” refers to a group containing a fluorine atom, and contains —F.

The polyisocyanate contained in the composition for forming the surface layer is a component important to improve the adhesion of the elastic layer with the surface layer. From the viewpoints to promote the self-crosslinking of the polyisocyanates themselves, to enhance the reactivity with the calcium carbonate, and the like, there is applied the polyisocyanate having two or more isocyanate groups in a molecule. The number of isocyanate groups in the molecule of the polyisocyanate is not specifically limited as long as being in the range of being capable of improving the adhesion of the elastic layer with the surface layer.

The polyisocyanate may be of any structure of an isocyanurate structure, a biuret structure and an adduct structure. The polyisocyanate preferably contains an isocyanurate structure. In this case, the adhesion of the elastic layer with the surface layer is easily improved.

Specific examples of the polyisocyanate include aliphatic, alicyclic or aromatic polyisocyanates, and derivatives of these isocyanates, such as isocyanurate structures, biuret structures and adduct structures. More specific examples of the isocyanate include aliphatic, alicyclic or aromatic diisocyanates, and derivatives of these diisocyanates, such as isocyanurate structures, biuret structures and adduct structures.

More specific examples of the polyisocyanate include hexamethylene diisocyanate (HDI), hexamethylene diisocyanate (HDI) series, isophorone diisocyanate (IPDI), isophorone diisocyanate (IPDI) series, xylene diisocyanate (XDI), xylene diisocyanate (XDI) series, hydrogenated xylene diisocyanate (H6XDI), hydrogenated xylene diisocyanate (H6XDI) series, diphenylmethane diisocyanate (MDI), diphenylmethane diisocyanate (MDI) series, tolylene diisocyanate (TDI), tolylene diisocyanate (TDI) series, naphthalene diisocyanate (NDI), naphthalene diisocyanate (NDI) series, and derivatives of these diisocyanates, such as isocyanurate structures, biuret structures and adduct structures. These can be used singly or concurrently in two or more. Here, the “series” mentioned in the above has a meaning of comprehensively including polyisocyanates whose bases are the same isocyanate, and derivatives of these isocyanates, such as isocyanurate structures, biuret structures and adduct structures. That is, for example, the “hexamethylene diisocyanate series” include various types of polyisocyanates having, as a base, hexamethylene diisocyanate, and derivatives of these isocyanates, such as isocyanurate structures, biuret structures and adduct structures. The other series have also the similar meaning.

The polyisocyanate may be a blocked polyisocyanate whose isocyanate groups are blocked with a blocking agent. The blocked polyisocyanate, since the isocyanate groups are protected with a blocking agent, has a lower reactivity at normal temperature than non-blocked polyisocyanates. Hence, the blocked polyisocyanate hardly causes the deterioration and the like due to the moisture in the production environment and the length of the production time for the charging member, and can suitably be used. Here, the blocking agent dissociates by heat applied when the composition for forming the surface layer is cured, and reproduces active isocyanate groups. Examples of the blocking agent include alcohol-based, phenol-based, active methylene-based, mercaptane-based, acid amide-based, acid imide-based, imidazole-based, urea, oxime-based, amine-based, imide-based and pyridine-based compounds.

In the composition for forming the surface layer, the content of the polyisocyanate can be, from the viewpoint of securing the effect of improving the adhesion of the elastic layer with the surface layer, and other effects, with respect to 100 parts by mass of the matrix polymer, preferably 5 parts by mass or higher, more preferably 10 parts by mass or higher, and still more preferably 20 parts by mass or higher. Further the content of the polyisocyanate can be, from the viewpoint of the processability and so on, with respect to 100 parts by mass of the matrix polymer, preferably 60 parts by mass or lower, more preferably 50 parts by mass or lower, and still more preferably 40 parts by mass or lower.

The porous particle contained in the composition for forming the surface layer is a component important to improve the adhesion of the elastic layer with the surface layer. The porous particle may be either an inorganic particle or an organic particle as long as having a large number of pores at least in the particle surface. Further the porous particle may be either insulating or conductive. The insulating porous particle has an advantage of easily contributing to cost reduction of the charging member. The conductive porous particle, since easily reducing the local differences in surface resistance, has an advantage of easily contributing to improving the uniform chargeability. Specific examples of the porous particle include a silica particle, a (meth)acrylic resin particle and a polyamide resin particle having a large number of pores. These can be used singly or concurrently in two or more. Among these, from the viewpoints of the adhesion of the elastic layer with the surface layer, the processability, the cost, and so on, preferable is the silica particle

In the composition for forming the surface layer, the content of the porous particle can be, from the viewpoint of securing the effect of improving the adhesion of the elastic layer with the surface layer and other effects, with respect to 100 parts by mass of the matrix polymer, preferably 5 parts by mass or higher, more preferably 10 parts by mass or higher, and still more preferably 25 parts by mass or higher. Further the content of the porous particle can be, from the viewpoint of the uniform chargeability and the like, with respect to 100 parts by mass of the matrix polymer, preferably 50 parts by mass or lower, more preferably 45 parts by mass or lower, and still more preferably 40 parts by mass or lower.

The average particle diameter of the porous particle can be, from the viewpoint of securing the effect of improving the adhesion of the elastic layer with the surface layer, and other effects, preferably 3 μm or larger, more preferably 4 μm or larger, and still more preferably 5 μm or larger. The average particle diameter of the porous particle can be, from the viewpoints of the dispersibility in the composition, the processability, and so on, preferably 30 μm or smaller, more preferably 25 μm or smaller, and still more preferably 20 μm or smaller. Here, the average particle diameter of the porous particle is a median diameter measured by dispersing the porous particle in methyl ethyl ketone (MEK), and using a laser diffraction scattering type particle size distribution analyzer (for example, “Microtrac HRA(X-100), manufactured by Nikkiso Co., Ltd.).

The composition for forming the surface layer can contain a conductive agent. Specific examples of the conductive agent include materials described in the above description of the elastic layer. The composition for forming the surface layer can contain, other than the conductive agent, one or more of various types of additives, for example, roughness forming particles to make the surface of the surface layer uneven, surface modifiers, dispersants and surfactants.

The thickness of the surface layer can be, from the viewpoint of the suppression of damage to the charging member surface, the suppression of damage to the photoreceptor, the improvement in the wear resistance, and so on, preferably about 0.5 to 20 μm, more preferably about 0.7 to 10 μm, and still more preferably about 1 to 8 μm. Here, in the case where the surface of the surface layer is made uneven, the thickness of the surface layer is a value measured at concave portions. The volume resistivity of the surface layer can be, from the viewpoints of the improvement in the charging ability, the suppression of the charge variation, and so on, preferably about 1×10⁴ to 1×10¹¹ Ω·cm, and more preferably about 1×10⁵ to 1×10¹⁰ Ω·cm.

Here, the respective constitutions described in the above can be combined optionally according to needs to provide the above-mentioned respective actions and effects and the like.

### EXAMPLE

Hereinafter, charging members of Examples will be described specifically, making use of the drawings.

### Example 1

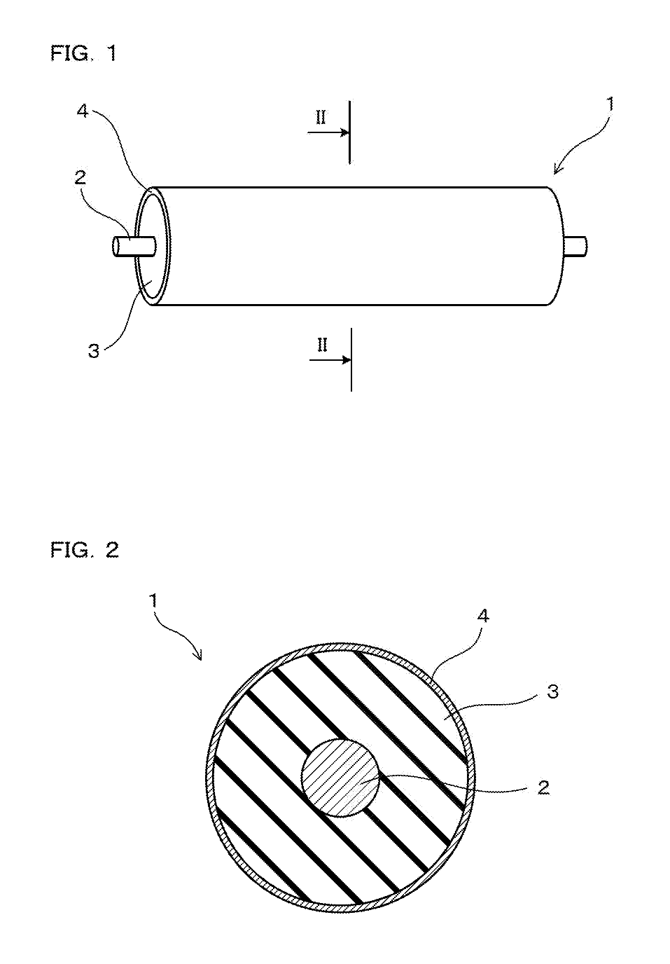

A charging member of Example 1 will be described by using FIG. 1 and FIG. 2. As shown in FIG. 1 and FIG. 2, a charging member 1 of the present Example is for use in an electrophotographic image forming device. Specifically, for its purpose, the charging member 1 is brought into contact with a photoreceptor in the electrophotographic image forming device to charge the surface of photoreceptor by applying a voltage thereto.

The charging member 1 has a shaft body 2 having conductivity, an elastic layer 3 having conductivity and formed along the outer circumference of the shaft body 2, and a surface layer 4 formed along the outer circumference of the elastic layer 3. The elastic layer 3 contains a rubber and a calcium carbonate having a spindle shape. The surface layer 4 contains a cured material of a composition containing a matrix polymer, a polyisocyanate having two or more isocyanate groups in a molecule, and a porous particle. The calcium carbonate in the elastic layer 3 exists more at a side closer to the surface layer 4 than at a side closer to the shaft body 2.

In the present Example, the elastic layer 3 contains 10 to 150 parts by mass of the calcium carbonate relative to 100 parts by mass of the rubber. The rubber is one or more selected from the group consisting of isoprene rubber, natural rubber, styrene-butadiene rubber, butadiene rubber, acrylonitrile-butadiene rubber and hydrin rubber. The elastic layer 3 is formed by extruding a rubber composition containing a predetermined rubber component and the calcium carbonate having a spindle shape, and thereafter subjecting the extruded material to a heat treatment. Further, the calcium carbonate having a spindle shape is oriented in the state that the major axis of the spindles is directed in the axial direction of the shaft body 2. The porous particle contained in the composition for forming the surface layer 4 contains one or more selected from the group consisting of a silica particle having a large number of pores, a (meth)acrylic resin particle having a large number of pores and a polyamide resin particle having a large number of pores.

Hereinafter, Examples will be described more specifically by using Experimental Examples.

### Experimental Examples

### Preparation of Materials for Forming Elastic Layers

Materials for use in preparation of a material for forming the elastic layer are as follows.

### —Rubber Components—

Isoprene rubber (IR) (“JSR IR2200”, manufactured by JSR Corp.)
Natural rubber (NR) (RSSI)
Styrene-butadiene rubber (SBR) (“Tufdene 2100”, manufactured by Asahi Kasei Chemicals Corp.)
Butadiene rubber (BR) (“Nipol BR1220”, manufactured by Zeon Corp.)
Nitrile rubber (NBR) (“DN219”, manufactured by Zeon Corp.)
Hydrin rubber (ECO) (“Epichlomer CG102”, manufactured by Daiso Co., Ltd.)

### —Spindle-Shaped Calcium Carbonates—

Spindle-shaped calcium carbonate (1) (major diameter: 300 nm, “Tunex-E”, manufactured by Shiraishi Kogyo Kaisha, Ltd.)
Spindle-shaped calcium carbonate (2) (major diameter: 1,200 nm, “PC-700”, manufactured by Shiraishi Kogyo Kaisha, Ltd.)

### —Other Additives—

Vulcanizing aid (zinc oxide) (“zinc oxide class 2”, manufactured by Mitsui Mining & Smelting Co., Ltd.)
Conductive agent (carbon black) (“Ketjen Black EC300J”, manufactured by Ketjen Black International Co., Ltd.)
Vulcanizing agent (sulfur) (manufactured by Tsurumi Chemical Industry Co., Ltd.)
Vulcanizing accelerator (2-mercaptobenzothiazole) (“Nocceler M-P”, manufactured by Ouchi Shinko Chemical Industrial Co., Ltd.)

One hundred parts by mass of a predetermined rubber indicated in Table 1 was masticated; thereafter, 5 parts by mass of the vulcanizing aid and 10 parts by mass of the conductive agent were added and kneaded for 2 min. Then, predetermined parts by mass of a predetermined spindle-shaped calcium carbonate indicated in Table 1 was added and kneaded for 5 min. Then, 2 parts by mass of the vulcanizing agent and 0.5 parts by mass of the vulcanizing aid were added to the obtained kneaded rubber on an open roll, and kneaded. By the above, a material for forming each elastic layer was prepared.

### Preparation of Compositions for Forming Surface Layers

Materials for use in preparation of a composition for forming the surface layer are as follows.

### —Matrix Polymer—

A fluorine-modified acrylate resin (“Defensa TR230K”, manufactured by DIC Corp.)

### —Polyisocyanates—

A polyisocyanate (1) (blocked tolylene diisocyanate) (“Colonate 2534”, manufactured by Nippon Polyurethane Industry Co., Ltd.)
A polyisocyanate (2) (blocked diphenylmethane diisocyanate) (“Colonate HX”, manufactured by Nippon Polyurethane Industry Co., Ltd.)
A polyisocyanate (3) (blocked hexamethylene diisocyanate) (“Colonate L”, manufactured by Nippon Polyurethane Industry Co., Ltd.)

### —Particles—

A particle (1) (porous, silica particle) (“Silysia 446”, manufactured by Fuji Silysia Chemical, Ltd.)
A particle (2) (porous, crosslinked polymethyl methacrylate particle) (“MBP-8”, manufactured by Sekisui Plastics Co., Ltd.)
A particle (3) (porous, polyamide resin particle) (“TR-1”, manufactured by Toray Industries, Inc.)
A particle (4) (non-porous, silica particle) (“Aerosil R972”, manufactured by Tetsutani & Co., Ltd.)

### Another Additive—

A conductive agent (carbon black) (“Denka Black HS-100”, manufactured by Denki Kagaku Kogyo K.K.)

As indicated in Table 1, predetermined parts by mass of the matrix polymer, predetermined parts by mass of a predetermined polyisocyanate, predetermined parts by mass of a predetermined particle and predetermined parts by mass of the conductive agent were blended. Then, 100 parts by mass of methyl ethyl ketone (MEK) was added to this blend, and mixed and stirred to thereby prepare a liquid composition for forming the surface layer.

### <Fabrication of Charging Roll Samples>

### —Formation of Elastic Layers—

As a shaft body, a core metal of a solid cylinder having a diameter of 6 mm was prepared, and an adhesive was applied on the outer circumference of the core metal. Each of the materials for forming the elastic layer was extruded in an uncured state on the outer circumference of the shaft body to form a roll shape, and vulcanized at 150° C. for 30 min. Thereby, each roll-shaped elastic layer (thickness: 1.25 mm) was formed along the outer circumference of the shaft body.

### —Formation of Surface Layers—

In each of Samples 1 to 18, the outer circumference of the elastic layer was coated with the composition for forming the surface layer by a roll coating method, and subjected to a heat treatment at 140° C. for 45 min. Thereby, each surface layer (thickness: 5 μm) was formed along the outer circumference of each elastic layer. By the above, charging roll samples 1 to 18 were fabricated.

<Observation of Cross-Sections of the Elastic Layers, and so on>

A cross-section of each charging roll in the direction perpendicular to the shaft body and a cross-section of each charging roll in the direction parallel to the shaft body were observed by a scanning electron microscope. As a result, excepting the charging roll of sample 17 containing no spindle-shaped calcium carbonate in the elastic layer, it was confirmed that the spindle-shaped calcium carbonate in the elastic layer in each charging roll was oriented in the state that the major axis of the calcium carbonate was directed in the axial direction of the shaft body. It was also confirmed that the spindle-shaped calcium carbonate in each charging roll existed more at a side closer to the surface layer than at a side closer to the shaft body.

### <Average Particle Diameters of the Particles Used for the Surface Layers>

Each particle was dispersed in methyl ethyl ketone (MEK), and the median diameter of the particle was measured by a laser diffraction scattering type particle size distribution analyzer (“Microtrac HRA(X-100), manufactured by Nikkiso Co., Ltd.). As a result, the average particle diameter of the particle (1) was 4 μm; the average particle diameter of the particle (2) was 8 μm; the average particle diameter of the particle (3) was 13 μm; and the average particle diameter of the particle (4) was 16 μm.

### <Evaluation of the Adhesion>

The surface of the surface layer of each charging roll was cut into with a cutter knife to form a 1 cm square part thereon. Then, a adhesive tape (“610S #50”, manufactured by Teraoka Seisakusho Co., Ltd.) was placed on the square part, and thereafter peeled off with a force of 0.45 kgf. The case where the square part was not peeled off at all was rated as excellent in the adhesion and denoted by “A+”. The case where although peeling-off was observed at corner portions of the scored part, the other portion exhibited no peeling-off was rated as very good in adhesion and denoted by “A”. The case where although peeling-off was observed at some portions of the scored part, the other portion exhibited no peeling-off was rated as good in adhesion and denoted by “B”. The case where the whole scored part was peeled off was rated as poor in adhesion and denoted by “C”.

<Evaluation of Peeling-Off after Endurance>

Each charging roll was assembled in a commercially available printer (“Color Laser Jet 4700dn”, manufactured by Hewlett-Packard Development Co.) of a direct current charging system, and aged for 24 hours in an environment of 32° C. and 85% RH. Thereafter, the image formation of 10,000 sheets of 2%-printing charts was carried out in the same environment. Then, the charging roll after the endurance was taken out from the printer, and the roll surface was observed visually. The case where no flaw and peeling-off was observed at all on the surface layer was rated as excellent in durability and denoted by “A+”. The case where flaws were observed on one or two places on the surface layer was rated as very good in durability and denoted by “A”. The case where although flaws were observed on more than two places on the surface layer, the surface layer was not peeled off was rated as being good in the durability and denoted by “B”. The case where the surface layer was peeled off was rated as poor in adhesion of the surface layer and low in durability, and denoted by “C”.

Hereinafter, the details of the elastic layers and the surface layers, and the evaluation results of the fabricated charging rolls are collectively shown in Table 1.

TABLE 1

| | | Samples | | | | | | | | |
|---|---|---|---|---|---|---|---|---|---|---|
| | | 1 | 2 | 3 | 4 | 5 | 6 | 7 | 8 | 9 |
| Material for forming elastic layer | Rubber | | | | | | | | | |
| (parts by mass) | IR | 100 | 100 | 100 | 100 | 100 | 100 | — | — | — |
| | NR | — | — | — | — | — | — | 100 | — | — |
| | SBR | — | — | — | — | — | — | — | 100 | — |
| | BR | — | — | — | — | — | — | — | — | 100 |
| | NBR | — | — | — | — | — | — | — | — | — |
| | ECO | — | — | — | — | — | — | — | — | — |
| | Spindle-shaped calcium carbonate (1) | 10 | 80 | 150 | — | — | — | 80 | 80 | 80 |
| | Spindle-shaped calcim carbonate (2) | — | — | — | 10 | 80 | 150 | — | — | — |
| Material for forming surface layer | Matrix polymer | 100 | 100 | 100 | 100 | 100 | 100 | 100 | 100 | 100 |
| (parts by mass) | Polyisocyanate (1) | 30 | 30 | 30 | 30 | 30 | 30 | 30 | 30 | 30 |
| | Polyisocyanate (2) | — | — | — | — | — | — | — | — | — |
| | Polyisocyanate (3) | — | — | — | — | — | — | — | — | — |
| | Particle (1)-Porous- | 10 | 10 | 10 | 10 | 10 | 10 | 10 | 10 | 10 |
| | Particle (2)-Porous- | — | — | — | — | — | — | — | — | — |
| | Particle (3)-Porous- | | | | | | | | | |
| | Particle (4)-Non-Porous- | — | — | — | — | — | — | — | — | — |
| | Conductive agent | 30 | 30 | 30 | 30 | 30 | 30 | 30 | 30 | 30 |
| Adhesion evaluation | | B | A | A+ | B | A | A+ | A | A | A |
| Peeling-off evaluation after endurance | | B | A | A+ | A | A | A+ | A | A | A |
| | | Samples | | | | | | | | |
| | | 10 | 11 | 12 | 13 | 14 | 15 | 16 | 17 | 18 |
| Material for forming elastic layer | Rubber | | | | | | | | | |
| (parts by mass) | IR | — | — | 100 | 100 | 100 | 100 | 100 | 100 | 100 |
| | NR | — | — | — | — | — | — | — | — | — |
| | SBR | — | — | — | — | — | — | — | — | — |
| | BR | — | — | — | — | — | — | — | — | — |
| | NBR | 100 | — | — | — | — | — | — | — | — |
| | ECO | — | 100 | — | — | — | — | — | — | — |
| | Spindle-shaped calcium carbonate (1) | 80 | 80 | 80 | 80 | 80 | 80 | 80 | — | 80 |
| | Spindle-shaped calcim carbonate (2) | — | — | — | | — | — | — | — | — |
| Material for forming surface layer | Matrix polymer | 100 | 100 | 100 | 100 | 100 | 100 | 100 | 100 | 100 |
| (parts by mass) | Polyisocyanate (1) | 30 | 30 | 30 | 30 | — | — | 30 | 30 | — |
| | Polyisocyanate (2) | — | — | — | — | 30 | — | — | — | — |
| | Polyisocyanate (3) | — | — | — | — | — | 30 | — | — | — |
| | Particle (1)-Porous- | 10 | 10 | — | — | 10 | 10 | — | — | — |
| | Particle (2)-Porous- | — | — | 10 | — | — | — | — | 10 | 10 |
| | Particle (3)-Porous- | | | | 10 | | | | | |
| | Particle (4)-Non-Porous- | — | — | — | — | — | — | 10 | — | — |
| | Conductive agent | 30 | 30 | 30 | 30 | 30 | 30 | 30 | 30 | 30 |

| | | | | | | | | | |
|---|---|---|---|---|---|---|---|---|---|
| Adhesion evaluation | A | A | A | A | A | A | C | C | C |
| Peeling-off evaluation after endurance | A | A | A | A | A | A | C | C | C |

Table 1 makes certain the following facts.

The charging roll of sample 16 contained no porous particle and contained non-porous particle in the composition for forming the surface layer. Hence, in the charging roll of sample 16, the adhesion of the elastic layer with the surface layer was poor and the surface layer was peeled off from the elastic layer.

The charging roll of sample 17 contained no spindle-shaped calcium carbonate in the elastic layer. Hence, in the charging roll of sample 17, the adhesion of the elastic layer with the surface layer was poor and the surface layer was peeled off from the elastic layer.

The charging roll of sample 18 contained no polyisocyanate in the composition for forming the surface layer. Hence, in the charging roll of sample 18, the adhesion of the elastic layer with the surface layer was poor and the surface layer was peeled off from the elastic layer.

By contrast, the charging rolls of sample 1 to sample 15 each had an elastic layer containing a rubber and a spindle-shaped calcium carbonate, and a surface layer composed of a cured material of a composition containing the matrix polymer, a polyisocyanate having two or more isocyanate groups in a molecule, and a porous particle. Hence, in the above charging rolls, the adhesion of the elastic layers with the surface layers could be improved. Further in the above charging rolls, it was confirmed that even in the case where the charging rolls were assembled in image forming devices and used for a long period, the surface layer was hardly peeled off from the elastic layer.

Hitherto, Examples of the present disclosure have been described in detail, but the present disclosure is not limited to the above Examples, and various modifications may be made within the range not impairing the gist of the present disclosure.

1. A charging member for use in an electrophotographic image forming device, the charging member comprising:
a shaft body having conductivity;
an elastic layer having conductivity and formed along an outer circumference of the shaft body; and
a surface layer formed along an outer circumference of the elastic layer; wherein
the elastic layer comprises a rubber and a calcium carbonate having a spindle shape,
the surface layer comprises a cured material of a composition comprising a matrix polymer, a polyisocyanate having two or more isocyanate groups in a molecule, and a porous particle, and
the calcium carbonate in the elastic layer exists more at a side closer to the surface layer than at a side closer to the shaft body.

2. The charging member according to claim 1, wherein the elastic layer comprises 10 to 150 parts by mass of the calcium carbonate relative to 100 parts by mass of the rubber.

3. The charging member according to claim 1, wherein the porous particle comprises one or more selected from the group consisting of a silica particle having a large number of pores, a (meth)acrylic resin particle having a large number of pores and a polyamide resin particle having a large number of pores.

4. The charging member according to claim 2, wherein the porous particle comprises one or more selected from the group consisting of a silica particle having a large number of pores, a (meth)acrylic resin particle having a large number of pores and a polyamide resin particle having a large number of pores.

5. The charging member according to claim 1, wherein the polyisocyanate comprises an isocyanurate structure.

6. The charging member according to claim 4, wherein the polyisocyanate comprises an isocyanurate structure.

7. The charging member according to claim 1, wherein the rubber is one or more selected from the group consisting of isoprene rubber, natural rubber, styrene-butadiene rubber, butadiene rubber, acrylonitrile-butadiene rubber and hydrin rubber.

8. The charging member according to claim 6, wherein the rubber is one or more selected from the group consisting of isoprene rubber, natural rubber, styrene-butadiene rubber, butadiene rubber, acrylonitrile-butadiene rubber and hydrin rubber.

9. The charging member according to claim 1, wherein the calcium carbonate is oriented in a state that a major axis of the calcium carbonate is directed in an axial direction of the shaft body.

10. The charging member according to claim 8, wherein the calcium carbonate is oriented in a state that a major axis of the calcium carbonate is directed in an axial direction of the shaft body.

11. The charging member according to claim 1, wherein the elastic layer is formed by extrusion.

12. The charging member according to any one of claim 10, wherein the elastic layer is formed by extrusion.

13. The charging member according to claim 1, wherein the calcium carbonate has an average aspect ratio of 1.0 or higher and 5.0 or lower.

14. The charging member according to claim 12, wherein the calcium carbonate has an average aspect ratio of 1.0 or higher and 5.0 or lower.

15. The charging member according to claim 1, wherein the calcium carbonate has an average aspect ratio of 2.0 or higher and 3.0 or lower.

16. The charging member according to claim 12, wherein the calcium carbonate has an average aspect ratio of 2.0 or higher and 3.0 or lower.

17. The charging member according to claim 1, wherein the calcium carbonate has a major diameter of 50 nm or longer and 3000 nm or lower.

18. The charging member according to claim 16, wherein the calcium carbonate has a major diameter of 50 nm or longer and 3000 nm or lower.

19. The charging member according to claim 1, wherein the calcium carbonate has a major diameter of 300 nm or longer and 1200 nm or lower.

20. The charging member according to claim 16, wherein the calcium carbonate has a major diameter of 300 nm or longer and 1200 nm or lower.
